(19) United States
(12) Patent Application Publication
(10) Pub. No.: US 2024/0391806 A1
(43) Pub. Date: Nov. 28, 2024

(54) TREATMENT COMPOSITION AND METHOD FOR TREATING A WATER SYSTEM

(71) Applicant: Ecolab USA Inc., St. Paul, MN (US)

(72) Inventors: Mingli WEI, Naperville, IL (US); Aarthi NARAYANAN, Lisle, IL (US)

(73) Assignee: Ecolab USA Inc., St. Paul, MN (US)

(21) Appl. No.: 18/673,139

(22) Filed: May 23, 2024

Related U.S. Application Data
(60) Provisional application No. 63/504,305, filed on May 25, 2023.

(51) Int. Cl. C02F 1/56; C02F 1/52

(52) U.S. Cl. CPC C02F 1/56; C02F 1/5236

(57) ABSTRACT

Described are treatment compositions for treating a water source, and methods of treating the water source. The composition includes one or more of an inorganic salt, a treatment polymer, and a particle. A flocculant may be added to the water source before or after the inorganic salt, treatment polymer, and particle. The methods and compositions may be used for treating wastewater, for example.

### TECHNICAL FIELD

The present disclosure relates to methods and compositions for the treatment of wastewater. More particularly, the disclosure relates to compositions comprising an inorganic salt and a treatment polymer and method of using the compositions to treat wastewater.

### BACKGROUND

Wastewater represents a major problem on a global scale. Many industries generate wastewater, which can create significant environmental issues and health hazards. Industrial and agricultural wastewaters cannot be drained off without treatment. Such environmental concerns have continually driven scientists and engineers to develop new materials and methods, which can lower the extent of pollution of the environment.

Flocculation plays a dominant role in wastewater treatment. Industrial wastewater, for example, can be treated with organic or inorganic flocculating agents, such as, vinyl polymers and natural polysaccharides (i.e., chitosan, and chitosan grafted with synthetic polymers) and inorganic coagulants. Flocculation is the process whereby particles are formed as a result of destabilization and are induced to come together, make contact and thereby form large and progressively larger agglomerates. In this case, the manifestation of destabilization is realized in practical terms: in effect, flocculation accelerates floc formation, influences the physical characteristics of flocs formed (e.g., their strength, size, and density), and governs the final concentration of destabilized particles. In wastewater treatment, coagulation and flocculation phenomena are extremely important.

Flocculating agents, or flocculants, are important components that cause flocculation, the process of bringing together small particles to form larger particles by adding small quantities of chemicals in water and wastewater treatment. Flocculants are classified into inorganic and organic categories. The inorganic flocculants (also called coagulants) with multivalent metals like aluminum and iron have been widely employed in wastewater treatment. Also, the organic flocculants based on acrylamide-based polymers, like polyacrylamide and its derivatives, are effective and as they possess the advantages, such as low dose, ease in handling, no interference with pH of the suspensions, and larger floc-forming capability.

### BRIEF SUMMARY

Certain aspects of the present disclosure relate to a method of removing suspended solids from a water source. The method comprises adding a treatment polymer and an inorganic salt to the water source, wherein a weight ratio of the inorganic salt to the treatment polymer added to the water source is from about 0.05:1 to 100:1.

In some embodiments, the inorganic salt is selected from the group consisting of an aluminum salt, a ferric salt, and any combination thereof.

In some embodiments, from about 1 ppm to about 10,000 ppm of the treatment polymer is added to the water source. In certain embodiments, from about 1 ppm to about 10,000 ppm of the inorganic salt is added to the water source.

In some embodiments, the treatment polymer comprises a Huggins constant of about 0.0 to about 1. In some embodiments, the treatment polymer comprises a conformation plot slope of about 0.05 to about 1.

In certain embodiments, the aluminum salt is selected from the group consisting of aluminum chloride, aluminum chloride hydrate, aluminum sulfate, alum, polyaluminum sulfate, PAC, aluminum chlorohydrate, a compound having the formula AlₙCl₍₃ₙ₋ₘ₎(OH)ₘ, wherein m is an integer from 0-100, n is an integer from 1-100, and m is less than 3n, and any combination thereof.

In some embodiments, the ferric salt is selected from the group consisting of ferric chloride, ferric sulfate, a polyferric salt, and any combination thereof.

In some embodiments, a composition comprises the treatment polymer and the inorganic salt, further wherein the composition comprises a pH from about 1.0 to about 8.5.

In certain embodiments, the treatment polymer is added to the water source before, after, and/or with the inorganic salt. In some embodiments, the inorganic salt and the treatment polymer are co-fed into the water source.

In some embodiments, the treatment polymer comprises a monomer selected from the group consisting of an anionic monomer, a cationic monomer, a non-ionic monomer, a zwitterionic monomer, and any combination thereof.

In certain embodiments, the treatment polymer comprises a monomer selected from the group consisting of acrylamide, methacrylamide, 2-(dimethylamino)ethyl acrylate (“DMAEA”), 2-(dimethylamino)ethyl methacrylate (“DMAEM”), 3-(dimethylamino) propyl methacrylamide (“DMAPMA”), 3-(dimethylamino) propyl acrylamide (“DMAPA”), 3-methacrylamidopropyl-trimethyl-ammonium chloride (“MAPTAC”), 3-acrylamidopropyl-trimethyl-ammonium chloride (“APTAC”), N-vinyl pyrrolidone (“NVP”), diallyldimethylammonium chloride (“DADMAC”), diallylamine, 2-(acryloyloxy)-N,N,N-trimethylethanaminium chloride (“DMAEA.MCQ”), 2-(methacryloyloxy)-N,N,N-trimethylethanaminium chloride (“DMAEM.MCQ”), N,N-dimethylaminoethyl acrylate benzyl chloride (“DMAEA.BCQ”), N,N-dimethylaminoethyl methacrylate benzyl chloride (“DMAEM.BCQ”), 2-acrylamido-2-methylpropane sulfonic acid (“AMPS”), 2-acrylamido-2-methylbutane sulfonic acid (“AMBS”), acrylamide tertbutylsulfonate (“ATBS”), [2-methyl-2-[(1-oxo-2-propenyl)amino]propyl]-phosphonic acid, acrylic acid, methacrylic acid, maleic acid, itaconic acid, a glyoxalated polyacrylamide (GPAM), a polyvinylamine (PVAM), a polyethylenimine (PEI), a polyamidoamine epichlorohydrin (PAE), a salt of any of the foregoing monomer units, and any combination thereof.

In some embodiments, the treatment polymer is a linear polymer.

In some embodiments, the treatment polymer is cationic, anionic, zwitterionic, non-ionic, amphoteric with a net positive charge or amphoteric with a net negative charge.

In certain embodiments, the treatment polymer comprises a carboxylic acid. In some embodiments, the polymer comprises from about 1 mol % to about 25 mol % of the carboxylic acid.

In some embodiments, the method further comprises forming a colloidal particle with the treatment polymer and the inorganic salt and adding the colloidal particle to the water source. In some embodiments, the method further comprises forming a colloidal particle in the water source with the treatment polymer and the inorganic salt.

In certain embodiments, the colloidal particle comprises the treatment polymer embedded within a colloidal aluminum hydroxide complex and/or a colloidal ferric hydroxide complex.

In some embodiments, the colloidal particle is water-insoluble. In some embodiments, the colloidal particle has an average particle size ranging from about 0.01 to about 1,000 microns.

In certain embodiments, the water source is a wastewater, a raw water, or an oil sand wastewater.

In some embodiments, a pH of the water source is adjusted to between about 5 and about 14.

In some embodiments, the suspended solids comprise a member selected from the group consisting of food waste, a microorganism, an oil particle, a grease particle, industrial waste, a sand particle, a gravel particle, a chemical precipitate, a fibrous material, an environmental pollutant, and any combination thereof.

In certain embodiments, the method further comprises adding a flocculant to the water source. In some embodiments, the flocculant comprises a member selected from the group consisting of a cationic polyacrylamide, an anionic polyacrylamide, an amphoteric polyacrylamide, and any combination thereof.

The present disclosure also provides a method of removing suspended solids from a water source. The method comprises adding a composition to the water source, wherein the composition comprises a colloidal particle, the colloidal particle comprising a polymer embedded within a colloidal aluminum hydroxide complex and/or a colloidal ferric hydroxide complex.

Additionally, the present disclosure provides a method of reducing turbidity of a water source. The method comprises adding a treatment polymer and an inorganic salt to the water source, wherein a weight ratio of the inorganic salt to the treatment polymer added to the water source is from about 0.05:1 to 100:1.

In some embodiments, the inorganic salt is selected from the group consisting of an aluminum salt, a ferric salt, and any combination thereof.

In some embodiments, from about 1 ppm to about 10,000 ppm of the treatment polymer is added to the water source. In certain embodiments, from about 1 ppm to about 10,000 ppm of the inorganic salt is added to the water source.

In some embodiments, the treatment polymer comprises a Huggins constant of about 0.0 to about 1. In some embodiments, the treatment polymer comprises a conformation plot slope of about 0.05 to about 1.

In certain embodiments, the aluminum salt is selected from the group consisting of aluminum chloride, aluminum chloride hydrate, aluminum sulfate, alum, polyaluminum sulfate, PAC, aluminum chlorohydrate, a compound having the formula AlₙCl₍₃ₙ₋ₘ₎(OH)ₘ, wherein m is an integer from 0-100, n is an integer from 1-100, and m is less than 3n, and any combination thereof.

In some embodiments, the ferric salt is selected from the group consisting of ferric chloride, ferric sulfate, a polyferric salt, and any combination thereof.

In some embodiments, a composition comprises the treatment polymer and the inorganic salt, further wherein the composition comprises a pH from about 1.0 to about 8.5.

In certain embodiments, the treatment polymer is added to the water source before, after, and/or with the inorganic salt. In some embodiments, the inorganic salt and the treatment polymer are co-fed into the water source.

In some embodiments, the treatment polymer comprises a monomer selected from the group consisting of an anionic monomer, a cationic monomer, a non-ionic monomer, a zwitterionic monomer, and any combination thereof.

In certain embodiments, the treatment polymer comprises a monomer selected from the group consisting of acrylamide, methacrylamide, DMAEA, DMAEM, DMAPMA, DMAPA, MAPTAC, APTAC, NVP, DADMAC, diallylamine, DMAEA.MCQ, DMAEM.MCQ, DMAEA.BCQ, DMAEM.BCQ, AMPS, AMBS, ATBS, [2-methyl-2-[(1-oxo-2-propenyl)amino]propyl]-phosphonic acid, acrylic acid, methacrylic acid, maleic acid, itaconic acid, a salt of any of the foregoing monomer units, and any combination thereof.

In some embodiments, the treatment polymer is a linear polymer. In some embodiments, the treatment polymer is cationic, anionic, zwitterionic, non-ionic, amphoteric with a net positive charge or amphoteric with a net negative charge. In certain embodiments, the treatment polymer comprises a carboxylic acid. In some embodiments, the polymer comprises from about 1 mol % to about 25 mol % of the carboxylic acid.

In some embodiments, the method further comprises forming a colloidal particle with the treatment polymer and the inorganic salt and adding the colloidal particle to the water source. In certain embodiments, the method further comprises forming a colloidal particle in the water source with the treatment polymer and the inorganic salt.

In some embodiments, the colloidal particle comprises the treatment polymer embedded within a colloidal aluminum hydroxide complex and/or a colloidal ferric hydroxide complex.

In some embodiments, the colloidal particle is water-insoluble.

In certain embodiments, the colloidal particle has an average particle size ranging from about 0.01 to about 1,000 microns.

In some embodiments, the water source is a wastewater, a raw water, or an oil sand wastewater.

In some embodiments, a pH of the water source is adjusted to between about 5 and about 14.

The present disclosure also provides a method of reducing turbidity of a water source. The method comprises adding a composition to the water source, wherein the composition comprises a colloidal particle, the colloidal particle comprising a polymer embedded within a colloidal aluminum hydroxide complex and/or a colloidal ferric hydroxide complex.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE DRAWINGS

FIG. 1 depicts a graph of pH effect on viscosity of polyaluminum chloride (PAC) and a carboxylic acid-containing polymer (CAP) blended samples.

FIG. 2 depicts a graph of the effect of PAC and CAP blended samples at various concentrations on the turbidity of the dairy sample.

FIG. 3 shows a bar graph, where a greater decrease in oil and grease is observed for 1200 ppm treatment composition of 95/5 PAC/CAP (PAC Blend B in the graph; CAP is diallyldimethylammonium chloride (DADMAC) containing 10% acrylic acid) as compared to 1500 ppm treatment with PAC alone (CAS #12042-91-0 in the figure).

FIG. 4 shows a graph of turbidity vs dosage of the treatment composition as compared to the conventional PAC composition in synthetic oily water.

### DETAILED DESCRIPTION

Various embodiments of the presently disclosed technology are described below. The relationship and functioning of the various elements of the embodiments may be better understood by reference to the following detailed description. However, embodiments are not limited to those explicitly described below.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)-groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo(fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The term “aluminum salt” as used herein refers to an inorganic compound containing an aluminum ion, which includes, but is not limited to, alum, aluminum chloride, aluminum sulfate, polyaluminum sulfate, PAC, and aluminum chlorohydrate. An aluminum salt is the compound that contributes aluminum ions in water solutions. It may include, but is not limited to, aluminum sulfate, aluminum chloride, aluminum phosphate, aluminum nitrate, and aluminum acetate.

The term “ferric salt” as used herein refers to an inorganic compound containing a ferric ion, which includes, but is not limited to, ferric chloride, ferric sulfate, polyferric sulfate, and polyferric chloride. A ferric salt is the compound that contributes ferric ions in water solutions. It may include, but is not limited to, ferric sulfate, ferric chloride, ferric phosphate, ferric nitrate, and ferric acetate.

The terms “co-feed,” “co-feeding,” “co-fed,” and the like refer to the addition of two or more components, ingredients, chemicals, and the like, to a location, such as a reaction vessel and/or storage container, separately but essentially/substantially at the same time and location. For example, two components, such as a treatment polymer and an inorganic salt, may be fed into a location, such as a reaction vessel, through separate injection pipes. Each pipe may continuously or intermittently inject chemical at the same time to a single location or to two or more locations in the reaction vessel that are in close proximity to each other (e.g., within about 1 to about 12 inches, such as from about 1 to about 10 inches, from about 1 to about 8 inches, or from about 1 to about 6 inches).

The term “degree of crosslinking” refers to how many connection bonds, on average, connect one polymer chain to another polymer chain. For example, a polymer sample with an average chain length of 1,000 monomer units, wherein 10 monomer units are connected to another chain has a degree of crosslinking of 1%.

The term “weight average molecular weight” refers to the molecular weight average of polymer determined by static light scattering measurement, specifically by Size-Exclusion-Chromatography/Multi-Angle-Laser-Light-Scattering (SEC/MALLS) technique. The polymer of the present disclosure has a weight average molecular weight of from about 10,000 to about 10,000,000 Daltons.

The term “average particle size” refers to the average size of particles determined by a dynamic light scattering particle size analyzer when particles are less than 10 microns and by a laser diffraction size analyzer when the particle size is between 1 and 1,000 microns. The particle of the present disclosure has an average particle size of from about 0.01 to about 1,000 microns.

The term “water source” means water comprising one or more targeted materials therein, wherein the one or more targeted materials are desirably separated from, passivated, or entrained within the water. In certain embodiments, the water sources addressed herein are industrial water sources, i.e., water having one or more targeted materials therein as a result of one or more industrial processes, raw water, oil sand wastewater. As used herein, the term “separated” means phase separated, such as accomplished by precipitation, flocculation, liquid-liquid phase separation, and the like. As used herein, the term “passivated” means that a deleterious effect of a targeted material is neutralized, negated, or diminished. As used herein, the term “entrained” means dissolved, dispersed, or emulsified. Industrial water sources include produced water emanating from hydrocarbon reservoirs or mines, recycled water used for cooling in industrial manufacturing processes, wastewater generated by one or more industrial processes such as papermaking or food processing, and other water sources generated by industrial processes.

The terms “wastewater” and “effluent water” may be used interchangeably to refer to any solution that has water as a primary component and is a discharge or effluent that includes one or more contaminants.

The term “targeted material” means one or more materials dissolved, suspended, emulsified, or dispersed in a water source, e.g., an industrial water source, that are treated by the composition and methods described herein. Exemplary, but non-limiting examples of targeted materials and corresponding water treatment compounds and/or methods include corrosive compounds targeted for an anti-corrosion treatment; compounds that tend to phase separate from water and deposit onto equipment surfaces, targeted for prevention of phase separation or prevention of deposition/precipitation; emulsified hydrocarbon compounds targeted for resolution (breaking) of the emulsion; microbes targeted for antimicrobial treatment; and dispersed solids targeted for coagulation or flocculation. The targeted material may also refer to a “contaminant,” which can be any substance or substances that are not desired in composition, material, location, etc., such as water. For example, a substance or substances not considered environmentally safe for direct discharge into a drain or other potable water systems can be considered a contaminant. Such substances include, but are not limited to, ions, organics, biochemical reagents, heavy metals, heavy metal complexes, inorganic salts, inorganic reagents, dissolved and suspended natural organic matter, clays, silicas, and any other chemically or biologically active bodies.

The terms “treat,” “treating,” “treatment,” “treatment method,” or “method of treating” further referring to treatment of a water source, refers to a process carried out to separate a targeted material from a water source, e.g., industrial water source, passivate a targeted material within a water source, or entrain a targeted material within a water source. Exemplary, but non-limiting examples of treatments include anti-corrosion treatments to passivate metal surfaces from corrodents present in an industrial water source, emulsion breaking treatments to cause liquid-liquid phase separation of a targeted material from the industrial water source, anti-scale treatments to prevent deposition of calcium scale on surfaces contacted by industrial water sources, antifreeze treatments to prevent solidification of or to prevent phase separation of an industrial water source in environments wherein the temperature is or may be near or below 0° C., paraffin inhibition treatments to prevent deposition of waxy petroleum-based solids on surfaces contacted by industrial water sources carrying hydrocarbons, flocculation/coagulation treatments to remove solid impurities from industrial water sources by precipitation, disinfection/sterilization treatments to neutralize or reduce microbial agents present in industrial water sources, purification treatments to remove various targeted materials from industrial water sources, polymerization inhibition treatments to reduce or prevent polymerization of hydrocarbon impurities present in industrial water sources, and the like. Specifically, in the context of the described composition and methods for treating a water source, the terms refer to treatments that improve liquid-solid separation processes within a water source, e.g., an industrial water source, as compared to a conventional treatment methods of water sources.

The terms “improve” or “improved” in reference to an improved treatment of a water source refers to a better performance in removing the targeted material from the water source with treatment using the treatment composition described herein as compared to the conventional treatment method(s). The degree of improvement will vary with the nature and quantity of the treatment composition present, but will be evident e.g., as a detectable improvement in reduction of the targeted material(s), such as contaminants from a water source, such as wastewater; desirably a degree of improvement is greater than 2.5%, 5%, 10%, 25%, 50%, 75%, 90%, 95%, or 99% as compared to a conventional treatment method.

The term “conventional treatment method” refers to a treatment of a water source with PAC or its derivative, polyDADMAC, alone. In certain embodiments, a conventional treatment method may refer to a treatment with a mixture of PAC with homo polyDADMAC, but the polyDADMAC has no reacting carboxylic acid group. This type of mixture is not pH dependent.

The terms “treatment composition” or “treatment formulation” refer to a product, such as a mixture of compounds added to one or more water sources to treat, improve, promote, decrease, manage, control, maintain, optimize, modify, reduce, inhibit, or prevent targeted material(s). The treatment composition or formulation described herein includes a metal-containing salt, such as an aluminum-based coagulant (e.g., PAC) or its derivatives and/or a ferric-based coagulant or its derivatives, and a treatment polymer, such as a CAP.

“Flocculation,” as used herein, refers to the destabilization of suspended particles present in water caused by such processes as polymer bridging and/or electrostatic interaction and charge neutralization. Flocculation often involves the formation of discrete globules of particles aggregated together with films of liquid carrier interposed between the aggregated globules, as used herein flocculation includes those descriptions recited in ASTME 20-85 as well as those recited in Kirk-Othmer Encyclopedia of Chemical Technology, 5th Edition, (2005), (Published by Wiley, John & Sons, Inc.), both of which are incorporated herein by reference in their entirety and for all purposes.

The terms “flocculant” or “flocculating agent,” may be used interchangeably and refer to a compound capable, upon application to water containing a plurality of suspended/dispersed particles, of removing some of the particles from suspension in the water to produce purer water. A flocculant is capable of flocculating suspended particles. For example, a flocculant can be a polymer capable, upon application to wastewater containing a plurality of suspended particles, of removing some of the particles from suspension in the wastewater to produce purer water. Flocculants can be organic or inorganic. Flocculant is distinguished herein from “flocculent,” which refers to the material that is flocculated by a flocculant. Flocculants are classified into inorganic and organic categories. The inorganic flocculants (also called coagulants) include multivalent metals like aluminum and iron. The organic flocculants include, e.g., acrylamide-based polymers, such as polyacrylamide and its derivatives.

The term “coagulant” refers to a treatment compound, or a derivative thereof, used in solid-liquid separation stage to neutralize charges of suspended solids/particles so that they can agglomerate. Coagulants are categorized as inorganic coagulants, organic coagulants, and blends of inorganic and organic coagulants. Inorganic coagulants include, but are not limited to, multivalent metals, such as aluminum or iron salts, such as aluminum sulfate/chloride, ferric chloride/sulfate, polyaluminum chloride, and/or aluminum chloride hydrate. Organic coagulants include, but are not limited to, positively charged polymeric compounds with low molecular weight, including but not limited to polyamines, polyquaternized polymers, polyDADMAC, epichlorohydrin dimethyl amine, and coagulants recited in Kirk-Othmer Encyclopedia of Chemical Technology, 5th Edition, (2005), (Published by Wiley, John & Sons, Inc.).

The term “aluminum-based coagulant” refers to an inorganic flocculant that includes aluminum and any compounds including the aluminum metal, and derivatives of these compounds; e.g., PAC and its derivatives. PAC is a polyhydroxy polynuclear complex of aluminum salt and has the general formula AlₙCl₍₃ₙ₋ₘ₎(OH)ₘ, where m, n is an integer from 0 to 100, m<3n. PAC can be in a liquid or powder form. “Polyaluminum chloride derivatives” or “PAC derivatives” refer to products of any ratios of AI, CI, OH in the formula, including aluminum chlorohydrate with different level of OH content, as compared to the level of OH of PAC. Commercial PAC products typically differ in Al content, and pH value.

The terms “carboxylic acid-containing polymer” or “CAP” refer to a polymer having carboxylic acid content (i.e., comprising at least one monomer having a carboxylic acid group). In certain embodiments, the CAP comprises up to 50 mol % carboxylic acid content. In certain other embodiments, the CAP comprises up to 40 mol % carboxylic acid content, up to 30 mol % carboxylic acid content, up to 20 mol % carboxylic acid content, or up to 10 mol % carboxylic acid content.

The term “surfactant” refers to a surface-active agent that may be anionic, cationic, amphoteric or non-ionic. Examples of surfactants include fatty alcohol ethoxylatesalkylphenol ethoxylates, EO/PO block copolymers, Span and Tween type surfactants, alkyl sulfates such as sodium lauryl sulfate, sodium laureth sulfate, docusate, quaternary ammonium salts such as cetrimonium bromide (CTAB) and dimethyldioctadecylammonium chloride.

The term “surfactant formulation,” refers to a composition that includes at least one surfactant. A flocculant/surfactant formulation is a form of surfactant formulation. A “flocculant/surfactant formulation” refers to a single composition that includes a flocculant and a surfactant.

The terms “purer water” or “purified water” refer to water from which some or all targeted materials and/or contaminants have been removed. The purity of the water may be defined by the content of Total Organic Carbon (TOC) or by transmission of visible light of 550 nm wavelength through the water sample (percent transmittance, % T). When TOC is used to define water purity, the “purer water” or “purified water” refer to water that has at least 50% less TOC than the water before the treatment with the described treatment composition, as measured by 0.02 M potassium dichromate solution. When percent transmittance is used to define water purity, the “purer water” or “purified water” refers to water that has at least 50% greater percent transmittance than the water before the treatment with the described composition. It is understood that since what constitutes a contaminant in water depends on what is subjectively considered undesirable, pure water herein can refer to water that includes solutes and other materials not considered contaminants in the context at hand.

“Polymer bridging” refers to the attachment of polymer chain segments to two or more particles in wastewater, which links them and induces flocculation.

The terms “simultaneous” and “at substantially the same time” as used herein refer to less than or within one minute of each other. In the context of mixing materials or formulations into a composition or solution, at substantially the same time refers to adding a second material or formulation to the composition or solution before a first added material or formulation is distributed in the composition or solution.

The term “non-crosslinked form” in reference to the described composition refers to a dormant composition of a treatment polymer and an inorganic salt at low pH that keeps it from crosslinking before use; i.e., during product feed the incoming water of higher pH automatically triggers the interaction by crosslinking that can result in better performance.

Certain aspects of the presently disclosed methods rely on a pH dependent interaction between an inorganic salt, such as an aluminum salt and/or a ferric salt, and a treatment polymer, such as a CAP, to provide in situ and/or onsite generation of structured coagulants or flocculants utilizing process water pH as a trigger mechanism. Described herein are methods for improving liquid-solid separation processes within industrial water treatment programs.

Surprisingly, it has been found that a composition comprising an inorganic salt, such as an aluminum salt and/or a ferric salt, and a treatment polymer, such as a CAP, showed improved performance of water purification, as compared to a conventional treatment of water, such as treatment with PAC alone.

Specifically, when a PAC solution was mixed with a treatment polymer at an acidic pH (e.g., pH of about or less than 4.0), the mixture remained liquid with minimal reaction, but the solution quickly became viscous or a gel when the pH was increased. This change in viscosity indicates formation of a new structured coagulant or complex (which may, in some embodiments, be hereinafter referred to as “CAP crosslinked PAC” or “treatment polymer crosslinked PAC” or “colloidal particle”) by interaction of PAC and the treatment polymer. In some embodiments, the treatment polymer of the present disclosure is chemically and/or physically entangled and/or embedded in a colloidal aluminum hydroxide and/or colloidal ferric hydroxide complex, which may be the structured coagulant or colloidal particle referred to above.

The pH dependent interaction between the inorganic salt and the treatment polymer provides a stable and concentrated composition at lower pH (typically pH<4.0), but at higher pH during application (typically pH>4.0) it triggers the reaction and generates a hybrid structured network, which results in an improved performance of the composition as compared to the standard treatment methods. In other words, by modifying the inorganic salt, such as modifying the polyaluminum structure of PAC, or its derivative(s), superior coagulants were produced. By applying this pH-triggered mechanism, it was surprisingly found that the new formulation performed better than polyaluminum alone with the potential benefits of less chemical consumption, less sludge formation, and lower cost.

It was also surprisingly discovered that the same technology can be applied by co-feeding and/or sequentially feeding the inorganic salt with the treatment polymer and triggering the interaction onsite.

Also, the same technology can be used to create labile crosslinked or structured flocculants/coagulants by a blend or co-feed of low level of, for example, a polyaluminum salt and/or a polyferric salt (e.g., <10%) and a carboxylate containing flocculant.

In certain embodiments, the treatment composition or formulation described herein comprises, consists essentially of, or consists of an inorganic salt, such as an aluminum salt and/or a ferric salt, or its derivative(s), and a treatment polymer, such as a CAP, wherein the pH of the composition is at or below pH 4, and wherein the composition is in a non-crosslinked or low crosslinked form. Upon dosing a water source with the treatment composition an improved treatment result(s) is observed, as compared to the treatment with conventional wastewater treatment compositions.

In some embodiments, the inorganic salt is a metal-containing salt, such as an aluminum salt and/or a ferric salt.

Any appropriate aluminum salt may be selected and used with the presently disclosed innovation. In some embodiments, the aluminum salt is selected from the group consisting of aluminum chloride, aluminum chloride hydrate, aluminum sulfate, alum, polyaluminum sulfate, PAC, aluminum chlorohydrate, a compound having the formula AlₙCl₍₃ₙ₋ₘ₎(OH)ₘ, wherein m is an integer from 0-100, n is an integer from 1-100, and m is less than 3n, and any combination thereof.

In certain embodiments, the aluminum-based coagulant may be PAC, or a derivative thereof. The PAC derivative may be a compound comprising any ratio of Al, Cl, OH based on the formula of AlₙCl₍₃ₙ₋ₘ₎(OH)ₘ, where m, n is an integer from 0 to 100, m<3n (Formula 1) and may be aluminum chlorohydrate having a level of OH content different from the OH content of PAC.

Any appropriate ferric salt may be selected and used with the presently disclosed innovation. In some embodiments, the ferric salt is selected from the group consisting of ferric chloride, ferric sulfate, a polyferric salt, and any combination thereof.

The treatment polymer of the present disclosure may be chemically and/or physically entangled and/or embedded in a colloidal aluminum hydroxide and/or colloidal ferric hydroxide complex. The treatment polymer may include one or more anionic monomers, one or more cationic monomers, one or more non-ionic monomers, one or more zwitterionic monomers, or any combination of these monomers.

In some embodiments, the treatment polymer has a net negative charge and in other embodiments, the treatment polymer has a net positive charge or a neutral charge. In certain embodiments, the treatment polymer is water-soluble. In some embodiments, the treatment polymer comprises a carboxylic acid group and may be referred to herein as a CAP.

For example, the treatment polymer may comprise from about 1 mol % to about 50 mol % of the carboxylic acid, such as about 1 mol % to about 40 mol %, about 1 mol % to about 30 mol %, about 1 mol % to about 20 mol %, about 1 mol % to about 10 mol %, about 10 mol % to about 50 mol %, about 20 mol % to about 50 mol %, about 30 mol % to about 50 mol % or about 40 mol % to about 50 mol %.

In some embodiments, the treatment polymer comprises from about 1 mol % to about 8 mol %, from about 1 mol % to about 7 mol %, from about 1 mol % to about 6 mol %, from about 1 mol % to about 5 mol %, from about 1 mol % to about 4 mol %, from about 1 mol % to about 3 mol %, or from about 1 mol % to about 2 mol % of the carboxylic acid, such as about 1 mol %, about 2 mol %, about 3 mol %, about 4 mol %, about 5 mol %, about 6 mol %, about 7 mol %, or about 8 mol % of the carboxylic acid.

Illustrative, non-limiting examples of non-ionic monomers that may be included in the treatment polymer may be selected from acrylamide, methacrylamide, N,N-dimethylacrylamide, N,N-diethylacrylamide, N-isopropylacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, diallylamine, allylamine, and the like.

Illustrative, non-limiting examples of anionic monomers include acrylic acid, and its salts, including, but not limited to sodium acrylate, and ammonium acrylate, methacrylic acid, and its salts, including, but not limited to sodium methacrylate, and ammonium methacrylate, AMPS, the sodium salt of AMPS, sodium vinyl sulfonate, styrene sulfonate, maleic acid, and its salts, including, but not limited to the sodium salt, and ammonium salt, sulfonate itaconate, sulfopropyl acrylate or methacrylate or other water-soluble forms of these or other polymerizable carboxylic or sulphonic acids, sulfomethylated acrylamide, allyl sulfonate, sodium vinyl sulfonate, itaconic acid, acrylamidomethylbutanoic acid, fumaric acid, vinylphosphonic acid, vinylsulfonic acid, allylphosphonic acid, sulfomethylated acrylamide, phosphonomethylated acrylamide, and the like.

Illustrative, non-limiting examples of cationic monomers include dialkylaminoalkyl acrylates and methacrylates and their quaternary or acid salts, including, but not limited to, dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dialkylaminoalkylacrylamides or methacrylamides and their quaternary or acid salts, such as acrylamidopropyltrimethylammonium chloride, dimethylaminoethyl acrylate methyl chloride quaternary salt, dimethylaminoethyl acrylate benzyl chloride quaternary salt, dimethylaminoethyl methacrylate methyl chloride quaternary salt, dimethylaminoethyl methacrylate benzyl chloride quaternary salt, methacrylarnidopropyl trimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate, diallyldiethylammonium chloride, diallyldimethylammonium chloride, and the like.

Illustrative, non-limiting examples of zwitterionic monomers include N,N-dimethyl-N-acryloyloxyethyl-N-(3-sulfopropyl)-ammonium betaine, N, N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine (MPC), 2-[(3-acrylamidopropyl)dimethylammonio]ethyl 2′-isopropyl phosphate (AAPI), 1-vinyl-3-(3-sulfopropyl) imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N, N-diallylamine ammonium betaine (MDABS), N,N-diallyl-N-methyl-N-(2-sulfoethyl) ammonium betaine, and the like.

In some embodiments, the treatment polymer comprises a monomer selected from the group consisting of acrylamide, methacrylamide, DMAEA, DMAEM, DMAPMA, DMAPA, MAPTAC, APTAC, NVP, DADMAC, diallylamine, DMAEA.MCQ, DMAEM.MCQ, DMAEA.BCQ, DMAEM.BCQ, AMPS, AMBS, ATBS, [2-methyl-2-[(1-oxo-2-propenyl)amino]propyl]-phosphonic acid, acrylic acid, methacrylic acid, maleic acid, itaconic acid, a salt of any of the foregoing monomer units, and any combination thereof.

In certain embodiments, the polymer comprises a GPAM, a PVAM, a PEI, a PAE, or any combination thereof.

Additional examples of treatment polymers can be found in Table 1.

TABLE 1

| | | MW | | |
|---|---|---|---|---|
| Sample | polymer chemistry | (SEC/MALLS) | | Comment |
| Polymer 1 | AcAm/AA/DMAEA.MCQ 48/2/50 (mol %) | >1 mil dalton | | latex |
| Polymer 2 | AcAm/AA/DMAEA.MCQ 45/5/50 (mol %) | >1 mil dalton | | latex |
| Polymer 3 | DADMAC/AA 90/10 (mol %) | 500-1000 | kd | solution |
| | | | | polymer |
| Polymer 4 | DADMAC/AA 95/5 (mol %) | 500-1000 | kd | solution |
| | | | | polymer |
| Polymer 5 | AcAm/AA/DMAEA.MCQ 40/30/30 (mol %) | 300-500 | kd | solution |
| | | | | polymer |
| Polymer 6 | AcAm/AA 95/5 mol % | 100 | kd | solution |
| | | | | polymer |
| Polymer 7 | AcAm/AA 99/1 mol % | 100 | kd | solution |
| | | | | polymer |
| Polymer 8 | AcAm/DMAEA.MCQ 90/10 (mol %) | 480 | kd | solution |
| | | | | polymer |
| Polymer 9 | AcAm/DMAEA.MCQ 90/10 (mol %) | 830 | kd | solution |
| | | | | polymer |
| Polymer 10 | AcAm/DMAEA.MCQ/AA/DAAM | 500 | kd | solution |
| | 85.5/8/4/2.5 (mol %) | | | polymer |
| Polymer 11 | AcAm/DMAEA.MCQ/AA/DAAM | 920 | kd | solution |
| | 85.5/8/4/2.5 (mol %) | | | polymer |
| Polymer 12 | AcAm/DMAEA.MCQ/AA/DAAM | 1300 | kd | solution |
| | 80.5/8/4/7.5 (mol %) | | | polymer |
| Polymer 13 | AcAm/DMAEA.MCQ/AAEM 90/5/5 | 550 | kd | solution |
| | (mol %) | | | polymer |
| Polymer 14 | AcAm/DMAEA.MCQ/AA 88/8/4 (mol %) | 510 | kd | solution |
| | | | | polymer |
| Polymer 15 | AcAm/APTAC 90/10 (mol %) | 490 | kd | solution |
| | | | | polymer |
| Polymer 16 | AcAm/DMAEA.MCQ/AA = 90/8/2 (mole %) | 540 | kd | solution |
| | | | | polymer |
| Polymer 17 | AcAm/DMAEA.MCQ/ATBS = 90/8/2 | 510 | kd | solution |
| | (mole %) | | | polymer |
| Polymer 18 | AcAm/AA = 96/4 (mol) | 530 | kd | solution |
| | | | | polymer |
| Polymer 19 | AcAm/DMAEA.MCQ/AA 88/8/4 (mol %) | 210 | kd | solution |
| | | | | polymer |
| Polymer 20 | AcAm/DMAEA.MCQ/AA 88/8/4 (mol %) | 240 | kd | MBA |
| | | | | crosslinked |
| Polymer 21 | AcAm/DMAEA.MCQ/AA 88/8/4 (mol %) | 310 | kd | MBA |
| | | | | crosslinked |
| Polymer 22 | AcAm/DMAEA.MCQ/AA 86/8/6 (mol %) | 470 | kd | solution |
| | | | | polymer |
| Polymer 23 | AcAm/DMAEA.MCQ/AA 84/8/8 (mol %) | 500 | kd | solution |
| | | | | polymer |
| Polymer 24 | AcAm/DMAEA.MCQ/AA 92/4/4 (mol %) | 520 | kd | solution |
| | | | | polymer |
| Polymer 25 | AcAm/DMAEA.MCQ/AA 88/8/4 (mol %) | 860 | kd | solution |
| | | | | polymer |
| Polymer 26 | AcAm/DMAEA.MCQ/ATBS 88/8/4 (mol %) | 540 | kd | solution |
| | | | | polymer |
| Polymer 27 | AcAm/DMAEA.MCQ/AA 88/8/4 (mol %) | 530 | kd | MBA |
| | | | | crosslinked |
| Polymer 28 | AcAm/DMAEA.MCQ/AA 88/8/4 (mol %) | 760 | kd | MBA |
| | | | | crosslinked |
| Polymer 29 | AcAm/DMAEA.MCQ/AA 86/8/6 (mol %) | 200 | kd | solution |
| | | | | polymer |
| Polymer 30 | AcAm/DMAEA.MCQ/AA 84/8/8 (mol %) | 210 | kd | solution |
| | | | | polymer |
| Polymer 31 | AcAm/ATBS = 88.3/11.7 (mol %) | 720 | kd | solution |
| | | | | polymer |
| Polymer 32 | AcAm/DMAEA.MCQ/AA 90/4/6 (mol %) | 260 | kd | solution |
| | | | | polymer |
| Polymer 33 | AcAm/DMAEA.MCQ/AA 91/8/1 (mol %) | 590 | kd | solution |
| | | | | polymer |
| Polymer 34 | AcAm/DMAEA.MCQ/MAA = 90/9.8/0.2 | ~1,000 | kd | dry powder |
| | (mole %) | | | |
| Polymer 35 | AcAm/DMAEA.MCQ/AA 88/8/4 (mol %) | ~1,000 | kd | dry powder |
| Polymer 36 | AcAm/DMAEA.MCQ/AA 83/15/2 (mol %) | ~1,000 | kd | dry powder |
| Polymer 37 | AcAm/DMAEA.MCQ/MAA = 90/9.5/0.5 | ~500 | kd | dry powder |
| | (mol %) | | | |
| Polymer 38 | AcAm/DMAEA.MCQ/MAA = 90/9.9/0.1 | ~2,000 | kd | dry powder |
| | (mol %) | | | |
| Polymer 39 | AcAm/MAA = 100 (mol %) | ~1,000 | kd | dry powder |
| Polymer 40 | Homopolyacrylamide | 570 | kd | solution |
| | | | | polymer |
| Polymer 41 | AcAm/DMAEA.MCQ/AA 88/8/4 | 1500 | kd | solution |
| | (mol %) | | | polymer |
| Polymer 42 | AcAm/DMAEA/AA 88/8/4 (mol %) | 530 | kd | Solution |
| | | | | polymer |

In Table 1, DAAM refers to diacetone acrylamide, AAEM refers to acetoacetoxyethyl methacrylate, and MAA refers to methacrylic acid. In some embodiments, the polymer comprises about 90 mol % acrylamide, about 8 mol % DMAEA.MCQ and about 2 mol % itaconic acid.

The mole percentage of each monomer in the treatment polymer is not particularly limited. In some embodiments, the treatment polymer comprises from about 1 mol % to about 99 mol % of the cationic monomer. For example, the treatment polymer may comprise from about 1 mol % to about 90 mol %, from about 1 mol % to about 80 mol %, from about 1 mol % to about 70 mol %, from about 1 mol % to about 60 mol %, from about 1 mol % to about 50 mol %, from about 1 mol % to about 40 mol %, from about 1 mol % to about 30 mol %, from about 1 mol % to about 20 mol %, from about 1 mol % to about 10 mol %, from about 10 mol % to about 99 mol %, from about 20 mol % to about 99 mol %, from about 30 mol % to about 99 mol %, from about 40 mol % to about 99 mol %, from about 50 mol % to about 99 mol %, from about 60 mol % to about 99 mol %, from about 70 mol % to about 99 mol %, from about 80 mol % to about 99 mol %, or from about 90 mol % to about 99 mol % of a cationic monomer.

In some embodiments, the treatment polymer comprises from about 1 mol % to about 99 mol % of the anionic monomer. For example, the treatment polymer may comprise from about 1 mol % to about 90 mol %, from about 1 mol % to about 80 mol %, from about 1 mol % to about 70 mol %, from about 1 mol % to about 60 mol %, from about 1 mol % to about 50 mol %, from about 1 mol % to about 40 mol %, from about 1 mol % to about 30 mol %, from about 1 mol % to about 20 mol %, from about 1 mol % to about 10 mol %, from about 10 mol % to about 99 mol %, from about 20 mol % to about 99 mol %, from about 30 mol % to about 99 mol %, from about 40 mol % to about 99 mol %, from about 50 mol % to about 99 mol %, from about 60 mol % to about 99 mol %, from about 70 mol % to about 99 mol %, from about 80 mol % to about 99 mol %, or from about 90 mol % to about 99 mol % of an anionic monomer.

In some embodiments, the treatment polymer comprises from about 1 mol % to about 99 mol % of a non-ionic monomer. For example, the treatment polymer may comprise from about 1 mol % to about 90 mol %, from about 1 mol % to about 80 mol %, from about 1 mol % to about 70 mol %, from about 1 mol % to about 60 mol %, from about 1 mol % to about 50 mol %, from about 1 mol % to about 40 mol %, from about 1 mol % to about 30 mol %, from about 1 mol % to about 20 mol %, from about 1 mol % to about 10 mol %, from about 10 mol % to about 99 mol %, from about 20 mol % to about 99 mol %, from about 30 mol % to about 99 mol %, from about 40 mol % to about 99 mol %, from about 50 mol % to about 99 mol %, from about 60 mol % to about 99 mol %, from about 70 mol % to about 99 mol %, from about 80 mol % to about 99 mol %, or from about 90 mol % to about 99 mol % of a non-ionic monomer.

In some embodiments, the treatment polymer comprises from about 1 mol % to about 99 mol % of a zwitterionic monomer. For example, the treatment polymer may comprise from about 1 mol % to about 90 mol %, from about 1 mol % to about 80 mol %, from about 1 mol % to about 70 mol %, from about 1 mol % to about 60 mol %, from about 1 mol % to about 50 mol %, from about 1 mol % to about 40 mol %, from about 1 mol % to about 30 mol %, from about 1 mol % to about 20 mol %, from about 1 mol % to about 10 mol %, from about 10 mol % to about 99 mol %, from about 20 mol % to about 99 mol %, from about 30 mol % to about 99 mol %, from about 40 mol % to about 99 mol %, from about 50 mol % to about 99 mol %, from about 60 mol % to about 99 mol %, from about 70 mol % to about 99 mol %, from about 80 mol % to about 99 mol %, or from about 90 mol % to about 99 mol % of a zwitterionic monomer.

In certain embodiments, the treatment polymer disclosed herein comprises from about 1 mol % to about 10 mol % of the cationic monomer and about 1 mol % to about 5 mol % of the anionic monomer. For example, the treatment polymer may comprise from about 5 mol % to about 10 mol % of the cationic monomer, such as about 6 mol %, about 7 mol %, about 8 mol %, or about 9 mol % of the cationic monomer, and about 1 mol %, about 2 mol %, about 3 mol %, about 4 mol %, or about 5 mol % of the anionic monomer.

In some embodiments, the treatment polymer is not a disaccharide or a polysaccharide. In certain embodiments, the treatment polymer excludes monosaccharide monomers. In certain embodiments, the composition or particle disclosed herein excludes a polysaccharide and/or an anionic polysaccharide. In some embodiments, the treatment polymer excludes a hydroxamic acid group, an isocyanate group, N-bromoamine and/or N-chloroamine. In certain embodiments, the treatment polymer comprises unmodified/unreacted amide and/or amine side chains. In some embodiments, if the treatment polymer comprises amide and/or amine side chains, less than 10% of those side chains, such as less than 9%, 8%, 7%, 6%, 5%, 4%, 3%, 2%, 1% or 0%, are modified/reacted with other functional groups before the treatment polymer is embedded within a colloidal aluminum hydroxide complex and/or a colloidal ferric hydroxide complex.

In some embodiments, a treatment polymer of the present disclosure is a water-soluble amphoteric polymer containing a carboxylic acid group. In certain embodiments, a treatment polymer of the present disclosure may be linear, branched, crosslinked, structured, synthetic, semi-synthetic, natural, and/or functionally modified. A treatment polymer of the present disclosure can be in the form of a solution, a dry powder, a liquid, or a dispersion, for example.

The weight average molecular weight of the treatment polymer is not particularly limited. In some embodiments, the treatment polymer has a molecular weight ranging from about 1,000 Da to about 20,000,000 Da. For example, the treatment polymer may have a molecular weight ranging from about 1,000 Da to about 15,000,000 Da, about 1,000 Da to about 10,000,000 Da, about 1,000 Da to about 5,000,000 Da, about 1,000 Da to about 2,500,000 Da, about 1,000 Da to about 1,000,000 Da, about 1,000 Da to about 500,000 Da, about 1,000 Da to about 250,000 Da, about 10,000 Da to about 5,000,000 Da, about 10,000 Da to about 3,000,000 Da, about 10,000 Da to about 1,000,000 Da, about 10,000 Da to about 750,000 Da, about 10,000 Da to about 500,000 Da, about 10,000 Da to about 250,000 Da, about 10,000 Da to about 100,000 Da, about 10,000 Da to about 50,000 Da, about 100,000 Da to about 10,000,000 Da, about 500,000 Da to about 10,000,000 Da, about 750,000 Da to about 10,000,000 Da, about 1,000,000 Da to about 10,000,000 Da, about 3,000,000 Da to about 10,000,000 Da, about 5,000,000 Da to about 10,000,000 Da or from about 8,000,000 Da to about 10,000,000 Da.

As additional examples, the weight average molecular weight of the treatment polymer may be from about 200,000 Da to about 1,000,000 Da, such as from about 200,000 Da to about 800,000 Da, from about 200,000 Da to about 600,000 Da, or from about 300,000 to about 500,000 Da.

In some embodiments, the treatment polymer of the present disclosure comprises a Huggins constant of about 0.0 to about 1.0. For example, the Huggins constant of a treatment polymer disclosed herein may be from about 0.1 to about 0.9, about 0.1 to about 0.8, about 0.1 to about 0.7, about 0.1 to about 0.6, about 0.1 to about 0.5, about 0.1 to about 0.4, about 0.1 to about 0.3, about 0.1 to about 0.2, about 0.2 to about 0.8, about 0.2 to about 0.7, or about 0.2 to about 0.6.

The Huggins Equation is an empirical equation used to relate the reduced viscosity of a dilute polymer solution to the concentration of the polymer in solution. The Huggins equation states:

$$\frac{{η}_{s}}{c} = [ η ] + {{k}_{H} [ η ]}^{2} c$$

where ηₛ is the specific viscosity of a solution at a given concentration of a polymer in solution, [η] is the intrinsic viscosity of the solution, k_{H} is the Huggins coefficient, and c is the concentration of the polymer in solution.

The Huggins equation is a useful tool because it can be used to determine the intrinsic viscosity [η] or IV, from experimental data by plotting ηₛ/c versus the concentration of the solution, c.

The Huggins constant may be calculated as follows:

$$Huggins constant = \frac{slope of ( RSV ∼ c )}{{IV}^{2}}$$

where “RSV” stands for reduced specific viscosity and “IV” stands for intrinsic viscosity. The RSV is measured at a given polymer concentration and temperature and calculated as follows:

$$RSV = \frac{[ ( \frac{η}{{η}_{o}} ) - 1 ]}{c}$$

wherein η=viscosity of polymer solution; η₀=viscosity of solvent at the same temperature; and c=concentration of polymer in solution. The units of concentration “c” are (grams/100 ml or g/deciliter). Therefore, the units of RSV are dL/g. In accordance with the present disclosure, for measuring RSV, the solvent used is 1.0 molar sodium nitrate solution. The polymer concentration is typically about 0.1 to about 1.0 g/dL. The RSV is measured at about 30° C. The viscosities n and no are measured using a Cannon Ubbelohde semimicro dilution viscometer, size 75.

In the SEC/MALLS analysis of the present disclosure, the polymer solution was diluted with an aqueous mobile phase (0.3M NaCl, 0.1M NaH2PO4, 25 ppm NaN3) to about 0.05%. About 200 μL of the solution was injected into a set of TSKgel PW columns (TSKgel GMPW+GMPW+G1000PW), and the mobile phase had a flow rate of about 1.0 mL/min. Bovine serum albumin (BSA) was used as standard for multiangle light scattering detector normalization. The calibration constant of the RI detector was verified with sodium chloride (NaCl).

Linearity of the treatment polymer can be defined using Huggins constant, with a lower Huggins constant indicating a more linear polymer.

Certain treatment polymers disclosed herein may have a conformation plot slope of about 0.05 to about 1.0. For example, the polymers may have a conformation plot slope of about 0.1 to about 1.0, about 0.2 to about 1.0, about 0.3 to about 1.0, about 0.4 to about 1.0, about 0.5 to about 1.0, about 0.05 to about 0.5, about 0.05 to about 0.3, or about 0.05 to about 0.1.

SEC/MALLS characterizes LCB (long chain branching) in macromolecules through conformation plots. A conformation plot is a log-log plot of the rms radius (radius of gyration, R_{g}) versus molar mass (M). Light scattering implemented as SEC/MALLS can effectively and rapidly characterize branching in polymers. Polymers with LCB exhibit lower slopes than the corresponding linear polymer, which differ depending on the extent of LCB. A conformation plot can be constructed by SEC/MALLS analysis (see AN1005: Identifying short-chain branched polymers with conformational analysis, Wyatt Technology, Chris Deng, Ph.D., the disclosure of which is incorporated into the present application in its entirety).

The conformation plot is acquired by taking the mean radius of gyration calculated based on the molecular weight at each point and the corresponding molecular weight on the chromatogram, and a corresponding slope is calculated from the conformation plot.

A linear polymer should have higher conformation slope, such as from about 0.5 to 1, about 0.6 to 1, about 0.7 to 1, or about 0.8 to 1. A crosslinked polymer should have a lower conformation slope, typically below about 0.5, such as from about 0 to about 0.4, about 0 to about 0.3, about 0 to about 0.2, or about 0 to about 0.1.

Illustrative, non-limiting examples of treatment polymers of the present disclosure along with their corresponding Huggins constant and conformation plot slope are listed in Table 2.

TABLE 2

| | | | | Conformation | Huggins | |
|---|---|---|---|---|---|---|
| Sample | polymer composition | MW | | Plot Slope | Constant | Comment |
| A | AcAm/DMAEA.MCQ/AA | 510o | kd | 0.92 | 0.37 | linear |
| | 88/8/4 (mol %) | | | | | |
| B | AcAm/DMAEA.MCQ/AA | 480 | kd | 0.82 | 0.33 | linear |
| | 88/8/4 (mol %) | | | | | |
| C | AcAm/DMAEA.MCQ/AA | 420 | kd | 0.92 | 0.31 | linear |
| | 88/8/4 (mol %) | | | | | |
| D | AcAm/DMAEA.MCQ/AA | 370 | kd | 0.52 | 0.39 | linear |
| | 88/8/4 (mol %) | | | | | |
| E | AcAm/DMAEA.MCQ/AA | 290 | kd | 0.56 | 0.32 | linear |
| | 88/8/4 (mol %) | | | | | |
| F | AcAm/DMAEA.MCQ/AA | 350 | kd | 0.55 | 0.42 | linear |
| | 88/8/4 (mol %) | | | | | |
| G | AcAm/DMAEA.MCQ/AA | 730 | kd | 0.4 | 0.28 | MBA |
| | 88/8/4 (mol %) | | | | | crosslinked |
| H | AcAm/DMAEA.MCQ/AA | 460 | kd | 0.53 | 0.3 | MBA |
| | 88/8/4 (mol %) | | | | | crosslinked |
| I | AcAm/DMAEA.MCQ/AA | 760 | kd | 0.43 | 0.39 | MBA |
| | 88/8/4 (mol %) | | | | | crosslinked |
| J | AcAm/DMAEA.MCQ/AA | 500 | kd | 0.79 | 0.36 | linear |
| | 90/8/2 (mol %) | | | | | |
| K | AcAm/DMAEA.MCQ/AA | 490 | kd | 0.85 | 0.44 | linear |
| | 90/8/2 (mol %) | | | | | |
| L | AcAm/DMAEA.MCQ/AA | 540 | kd | 0.8 | 0.3 | linear |
| | 90/8/2 (mol %) | | | | | |
| M | AcAm/DMAEA.MCQ/AA | 730 | kd | 0.31 | 0.11 | MBA |
| | 90/8/2 (mol %) | | | | | crosslinked |
| N | AcAm/DMAEA.MCQ/AA | 480 | kd | 0.4 | 0.11 | MBA |
| | 90/8/2 (mol %) | | | | | crosslinked |
| O | AcAm/DMAEA.MCQ/AA | 940 | kd | 0.33 | 0.18 | MBA |
| | 90/8/2 (mol %) | | | | | crosslinked |
| P | AcAm/DMAEA.MCQ/AA | 1100 | kd | 0.3 | 0.35 | MBA |
| | 90/8/2 (mol %) | | | | | crosslinked |
| Q | AcAm/DMAEA.MCQ/AA | 940 | kd | 0.37 | 0.4 | MBA |
| | 90/8/2 (mol %) | | | | | crosslinked |
| R | AcAm/DMAEA.MCQ/AA | 820 | kd | 0.39 | 0.3 | MBA |
| | 90/8/2 (mol %) | | | | | crosslinked |
| S | AcAm/DMAEA.MCQ/AA | 570 | kd | 0.54 | 0.4 | MBA |
| | 90/8/2 (mol %) | | | | | crosslinked |
| T | AcAm/DMAEA.MCQ/AA | 950 | kd | 0.36 | 0.33 | MBA |
| | 90/8/2 (mol %) | | | | | crosslinked |
| U | AcAm/AA/DMAEA/AA | 530 | kd | 0.87 | 0.25 | linear |
| | 88/8/4 (mol %) | | | | | |

In some embodiments, the treatment polymer may be crosslinked with the aluminum or iron of the aluminum hydroxide complex or the ferric hydroxide complex. In some embodiments, the treatment polymer has a degree of crosslinking greater than 1%, greater than 2%, greater than 3%, greater than 4%, greater than 5%, greater than 6%, greater than 7%, greater than 8%, greater than 9% or greater than 10%. In certain embodiments, the treatment polymer has a degree of crosslinking less than about 50%, less than about 40%, less than about 30% or less than about 20%. For example, the treatment polymer may have a degree of crosslinking from about 1% to about 50%, from about 5% to about 50%, from about 10% to about 50%, from about 15% to about 50%, from about 20% to about 50%, from about 30% to about 50%, from about 2% to about 25%, from about 2% to about 20%, from about 2% to about 15%, from about 2% to about 10%, from about 3% to about 25%, from about 3% to about 20%, from about 3% to about 15%, from about 3% to about 10%, from about 4% to about 25%, from about 4% to about 20%, from about 4% to about 15% or from about 4% to about 10%.

In some embodiments, the crosslink is formed from an interaction/reaction of an anionic monomer and the iron and/or aluminum. For example, the treatment polymer may comprise a carboxylic acid group and a crosslink may be formed from a reaction/interaction between the carboxylic acid group and the iron and/or aluminum.

An aqueous medium may comprise the colloidal particle (thereby forming an aqueous colloidal treatment composition) and the aqueous medium may have a pH, for example, from about 2 to about 8.5, from about 4.5 to about 8.5, from about 5.5 to about 8.5, from about 5.5 to about 8, from about 6 to about 8 or from about 7 to about 8. In some embodiments, the aqueous medium comprises a pH from about 3.5 to about 8.5. In some embodiments, the colloidal particle is water-insoluble.

In certain embodiments, the colloidal particle is prepared by adding a treatment polymer disclosed herein to an aqueous solvent, such as water, and then adding an inorganic salt, such as an aluminum salt and/or ferric salt, to the solvent. The treatment polymer and metal salt can be added continuously, intermittently, and in any order. In some embodiments, the treatment polymer and metal salt are co-fed into the solvent.

In some embodiments, the solvent comprises about 0.01 wt. % to about 10 wt. % of the treatment polymer, such as from about 0.01 wt. % to about 9 wt. %, about 0.01 wt. % to about 8 wt. %, about 0.01 wt. % to about 7 wt. %, about 0.01 wt. % to about 6 wt. %, about 0.01 wt. % to about 5 wt. %, about 0.01 wt. % to about 4 wt. %, about 0.01 wt. % to about 3 wt. %, about 0.01 wt. % to about 2 wt. %, or about 0.01 wt. % to about 1 wt. % of the treatment polymer.

In some embodiments, the solvent comprises a weight ratio of the aluminum salt and/or the ferric salt to the treatment polymer from about 0.05:1 to 100:1. For example, the solvent may comprise a weight ratio of the aluminum salt and/or the ferric salt to the treatment polymer from about 0.1:1, about 0.5:1, about 1:1, about 5:1, about 10:1, about 20:1, about 30:1, about 40:1, about 50:1, about 60:1, about 70:1, about 80:1, or about 90:1. In some embodiments, the solvent comprises more aluminum salt and/or ferric salt than treatment polymer.

As an illustrative example, if a weight ratio of PAC (based on Al₂O₃) to the polymer was about 1:1, the aluminum ion would be about 159 mol % of the treatment polymer. As an additional, non-limiting example, if a weight ratio of PAC to treatment polymer was about 0.1:1, the aluminum ion would be about 15.9 mol % of the treatment polymer.

The aqueous solvent may have a pH from, for example, about 1.0 to about 6.5 and, after at least some of the polymer and metal salt have been added, the pH may be raised to about 7.0, about 7.5, about 8.0, about 8.5, or higher. In some embodiments, the pH of the composition may be raised by adding a base, such as sodium hydroxide, diluting the composition with water, etc. In certain embodiments, the pH of the composition is raised by adding it to a papermaking process water, wherein a pH of the papermaking process water may be from, for example, about 6.5 to about 8.5. While an amount of colloidal particle may form in the composition before the pH is raised, the substantial majority or all of the colloidal particle forms after the pH is raised.

The colloidal particle has a weight ratio of aluminum hydroxide and/or ferric hydroxide to the treatment polymer from about 0.1:99 to about 99:0.1. For example, the weight ratio may be from about 0.1:50 to about 50:0.1, from about 0.1:25 to about 25:0.1, from about 0.1:10 to about 10:0.1, from about 0.1:5 to about 5:0.1 or from about 0.1:2 to about 2:0.1. In certain embodiments, a weight ratio of the aluminum hydroxide and/or ferric hydroxide to the treatment polymer is from about 0.1:1 to about 2:1. In some embodiments, a weight ratio of the aluminum hydroxide and/or ferric hydroxide to the treatment polymer is from about 0.1:1 to about 0.9:1 or 0.1:1 to about 0.5:1.

The colloidal particle comprises from about 1 wt. % to about 99 wt. % of the treatment polymer. For example, the colloidal particle may comprise form about 5 wt. % to about 99 wt. %, from about 5 wt. % to about 95 wt. %, from about 10 wt. % to about 99 wt. %, or from about 10 wt. % to about 90 wt. % of the treatment polymer.

The colloidal particle comprises from about 1 wt. % to about 99 wt. % of the aluminum hydroxide and/or the ferric hydroxide. For example, the colloidal particle may comprise form about 5 wt. % to about 99 wt. %, from about 5 wt. % to about 95 wt. %, from about 10 wt. % to about 99 wt. %, or from about 10 wt. % to about 90 wt. % of the aluminum hydroxide and/or the ferric hydroxide.

The weight ratio of the treatment polymer to inorganic salt may be determined by other ancillary components in the composition and/or the type of water source to be treated. For example, when the water source is a dairy water, the weight ratio may be about 99:1 inorganic salt to treatment polymer to 95:5 inorganic salt to treatment polymer. However, this is more difficult to determine, it is case by case to determine which program to use, but it is generally categorized by its use of coagulant or flocculant as described in the following paragraph.

In certain embodiments, the treatment composition or formulation is a “high inorganic salt composition,” which means that inorganic salt>90% and treatment polymer<10%. In this specific formulation, the inorganic salt functions as a coagulant and pH-triggered crosslinker to generate structured high molecular weight inorganic salt, such as PAC.

In certain other embodiments, the treatment composition may be a “low inorganic salt composition” which means that the level of treatment polymer is high, e.g., inorganic salt<10% and treatment polymer>90%. In this specific formulation, the treatment polymer functions as a flocculant and the inorganic salt functions as the pH triggered crosslinker to generate structured high molecular weight flocculant.

The colloidal particle has an average particle size ranging from about 0.01 to about 1,000 microns. For example, the average particle size may be from about 0.05 to about 100 microns, from about 0.05 to about 80 microns, from about 0.05 to about 60 microns, from about 0.05 to about 40 microns, from about 0.05 to about 20 microns, from about 0.05 to about 10 microns, from about 0.1 to about 50 microns, from about 0.1 to about 40 microns, from about 0.1 to about 30 microns, from about 0.1 to about 20 microns, or from about 0.1 to about 10 microns.

As additional examples, the average particle size may be from about 50 nm to about 500 nm, such as from about 50 nm to about 400 nm, about 50 nm to about 300 nm, about 100 nm to about 200 nm, about 100 nm to about 300 nm, or about 100 nm to about 400 nm.

In some embodiments, the colloidal particle has a zeta potential ranging from about −50 to about +70 mV. For example, the colloidal particle may have a zeta potential ranging from about −40 to about +60, about −30 to about +50, about −20 to about +40, about −10 to about +30, or about 0 to about +30 mV.

In some embodiments, the colloidal particles may be added to the aqueous medium, such as wastewater, at about 1 ppm to about 10,000 ppm, based on the aqueous medium. For example, the colloidal particles may be added at about 1 ppm to about 8,000 ppm, about 1 ppm to about 6,000 ppm, about 1 ppm to about 4,000 ppm, about 1 ppm to about 2,000 ppm, about 1 ppm to about 1,000 ppm, about 1 ppm to about 500 ppm, about 1 ppm to about 250 ppm, about 1 ppm to about 100 ppm, about 50 ppm to about 10,000 ppm, about 100 ppm to about 10,000 ppm, about 250 ppm to about 10,000 ppm, about 500 ppm to about 10,000 ppm, about 1,000 ppm to about 10,000 ppm, about 3,000 ppm to about 10,000 ppm, about 5,000 ppm to about 10,000 ppm, or about 7,500 ppm to about 10,000 ppm, based on the aqueous medium.

The treatment compositions provided herein may comprise any component disclosed herein, such as a particle, a treatment polymer, and/or an inorganic salt, and the treatment compositions may also comprise an optional agent selected from pH adjustment agents, antifreeze agents, corrosion inhibitors, purifiers, softeners, paraffin inhibitors, antiscale agents, biocides, fungicides, stabilizers, emulsifiers, hydrotropes, emulsion breakers, antifouling compounds, chelating agents, surfactants, oxygen scavengers, rheology control agents, surfactants, defoamers, foam inhibitors, hydrate inhibitors, dispersants, asphaltene inhibitors, sulfide inhibitors, and the like.

Scaling is the term used to describe the hard surface coating of calcium carbonate, magnesium carbonate, and byproducts thereof that forms on metallic surfaces within metal containments carrying industrial water sources with high total dissolved solids, such as produced water, brackish water, sea water, and other sources of divalent carbonates. Exemplary antiscale agents can include, but are not limited to, oligomeric and polymeric compounds with borate, carboxylate, phosphate, sulfonate, or another anionic moiety.

Exemplary agents employed to adjust pH of the composition, or in the instance of an onsite or insitu treatment, one or more water sources include but are not limited to water, Bronsted acids, conjugate bases and salts thereof and mixtures thereof to provide a selected pH for the industrial water source to be treated. The acids may be strong acids, that is, acids having a pKa of less than about 4; and weak acids, that is, acids having a pKa of about 4 or greater. In some embodiments, organic acids are weak acids. The pH adjustment agents are employed to adjust the pH of the water source to a selected value or range thereof, which may be anywhere from pH of about 1 to 12.

Exemplary antifouling compounds include, but are not limited to, copolymers of unsaturated fatty acids, primary diamines, and acrylic acid; copolymers of methacrylamidopropyl trimethylammonium chloride with acrylic acid and/or acrylamide; copolymers of ethylene glycol and propylene glycol; and blends of two or more thereof.

Exemplary chelating agents include, but are not limited to, compounds that are effective to reduce or remove one or more metal ions from an industrial water source. Chelation involves the formation or presence of two or more separate coordinate bonds between a polydentate (multiple bonded) ligand and a single central atom. Usually these ligands are organic compounds, and are called chelants, chelators, chelating agents, or sequestering agents.

Exemplary antimicrobials include, but are not limited to, compounds with a microbiostatic, disinfectant, or sterilization effect on the water source, e.g., industrial water source, when added thereto. Nonlimiting examples of antimicrobials include bactericides, fungicides, nematicides, and the like. Bactericides include active chlorine disinfectants, e.g. including hypochlorites, chlorine dioxide, and the like; phenols such as triclosan, phenol itself, thymol, and the like; cationic surfactants such as quaternary ammonium surfactants, chlorhexidine, and the like; ozone, permanganates, colloidal silver, silver nitrate, copper based compounds, iodine preparations, peroxides, and strong acids and strong alkalis wherein the water source is caused to have a pH of greater than about 12 or less than about 1. Fungicides include, but are not limited to, strobilurins such as azoxystrobin, trifloxystrobin and pyraclostrobin; triazoles and anilino-pyrimidines such as tebuconazole, cyproconazole, triadimefon, pyrimethanil; and additionally compounds such as triadimefon, benomyl, captan, chlorothalonil, copper sulfate, cyproconazole, dodine, flusilazole, flutolanil, fosetyl-al, gallex, mancozeb, metalaxyl, prochloraz, propiconazole, tebuconazole, thiophanate methyl, triadimenol, tridimefon, triphenyltin hydroxide, ziram, and the like.

In certain embodiments, an optional agent may be present in the treatment composition in an amount ranging from about 0.1 wt. % to about 50 wt. %, such as from about 0.1 wt. % to about 40 wt. %, about 0.1 wt. % to about 30 wt. %, about 0.1 wt. % to about 20 wt. %, about 0.1 wt. % to about 15 wt. %, about 0.1 wt. % to about 10 wt. %, about 0.1 wt. % to about 5 wt. %, or about 0.1 wt. % to about 2 wt. %.

Further, the compositions described herein may include one or more additives or adjuvants that are different from the optional agents. Additives or adjuvants such as solvents, polymers, surfactants, oils, fillers, buffers, viscosity modifiers, masking agents, colorants, and the like are optionally added to the treatment compositions as determined by the operator in conjunction with the specific water source and other variables.

In certain embodiments, the additive and/or adjuvant may be present in the treatment composition in an amount ranging from about 0.1 wt. % to about 50 wt. %, such as from about 0.1 wt. % to about 40 wt. %, about 0.1 wt. % to about 30 wt. %, about 0.1 wt. % to about 20 wt. %, about 0.1 wt. % to about 15 wt. %, about 0.1 wt. % to about 10 wt. %, about 0.1 wt. % to about 5 wt. %, or about 0.1 wt. % to about 2 wt. %.

The present disclosure also provides methods of using the presently disclosed compositions and particles in wastewater treatment applications. In some embodiments, a composition comprising the particle is added to the wastewater. For example, the treatment polymer may be premixed with a trivalent ion, such as an aluminum salt and/or a ferric salt, in an aqueous medium to form the particle and the resulting mixture may be added to the wastewater.

In some embodiments, a composition comprises the treatment polymer and inorganic salt, such as the aluminum salt and/or the ferric salt. This composition may optionally comprise an amount of a colloidal particle as defined herein, such as from about 0 wt. % to about 20 wt. %, about 0 wt. % to about 15 wt. %, about 0 wt. % to about 10 wt. %, about 0 wt. % to about 5 wt. %, or about 0 wt. % to about 1 wt. %.

The composition may be an aqueous composition comprising a pH from about 1 to about 14, such as from about 1 to about 10, from about 1 to about 9, from about 1 to about 8.5, from about 3 to about 14, from about 3 to about 10, from about 3 to about 8.5, from about 3.5 to about 8.5, from about 5 to about 14, from about 5 to about 10 or from about 5 to about 8. In certain embodiments, the composition comprises a pH of about 1 to about 7, such as from about 3 to about 5.

In some embodiments, the composition comprises a weight ratio of the aluminum salt and/or the ferric salt to the treatment polymer from about 0.05:1 to 100:1. For example, the composition may comprise a weight ratio of the aluminum salt and/or the ferric salt to the treatment polymer from about 0.1:1, about 0.5:1, about 1:1, about 5:1, about 10:1, about 20:1, about 30:1, about 40:1, about 50:1, about 60:1, about 70:1, about 80:1, or about 90:1. In some embodiments, the composition comprises more aluminum salt and/or ferric salt than treatment polymer.

In certain embodiments, the composition comprises from about 0.01 wt. % to about 10 wt. % of the treatment polymer. For example, the composition may comprise from about 0.01 wt. % to about 9 wt. %, from about 0.01 wt. % to about 8 wt. %, from about 0.01 wt. % to about 7 wt. %, from about 0.01 wt. % to about 6 wt. %, from about 0.01 wt. % to about 5 wt. %, from about 0.01 wt. % to about 4 wt. %, from about 0.01 wt. % to about 3 wt. %, from about 0.01 wt. % to about 2 wt. %, or from about 0.01 wt. % to about 1 wt. % of the treatment polymer.

In some embodiments, the treatment polymer comprises one or more anionic monomers. The pH of the aqueous composition may be adjusted such that it is greater than the lowest pka value of a monomer of the treatment polymer. The pKa of an anionic monomer equals the pH value while 50% anionic monomer carries an anionic charge. When the solution pH is higher than the pKa, more anionic charge sites will appear on the polymer chain that can promote its interaction with trivalent ions and their derivatives. If the aqueous composition comprising the treatment polymer is being added separately from the inorganic salt, such as when the treatment polymer and inorganic salt are being co-fed, the pH of the aqueous composition comprising the treatment polymer may be adjusted as described in the foregoing paragraph.

In some embodiments, the treatment polymer and the inorganic salt are co-fed into a location, such as into a reaction vessel, a storage tank, and/or into an aqueous medium, such as wastewater. Other components, such as a flocculant, a corrosion inhibitor, a chelating agent, etc., may also be co-fed alongside the treatment polymer and/or inorganic salt. In some embodiments when the treatment polymer and inorganic salt are co-fed into a location, the particle is formed in the location, such as in a reaction vessel or a storage tank. In some embodiments, the wastewater receiving the treatment polymer, inorganic salt, and/or colloidal particle has a near-neutral pH, such as a pH from about 5.5 to about 8.5 or from about 6 to about 8.

For example, an injection pipe may lead to a location in the wastewater and the pipe may inject treatment polymer into the wastewater. An adjacent pipe may be present and it may add additional chemical, such as inorganic salt. Each chemical addition may be continuous or intermittent, for example. Since the injection pipes are adjacent or substantially adjacent to one another, the chemicals are fed to substantially the same location in the wastewater at substantially the same time. The chemicals may interact in the wastewater and form a colloidal particle.

Thus, in some embodiments, a colloidal particle is formed in the wastewater and optionally a colloidal particle is additionally or alternatively added to the wastewater. In some embodiments, a colloidal particle may form in a composition before the composition is added to the wastewater and optionally a colloidal particle may form in the wastewater. In certain embodiments, a flocculant may be added before, after, and/or with the colloidal particle, treatment polymer, and/or inorganic salt.

The compositions, particles, treatment polymers, and/or inorganic salts can be added at any location or at any time during a wastewater treatment process. Two or more of the components may be added together and/or two or more components may be co-fed into the wastewater. For example, the compositions, particles, treatment polymers, and/or inorganic salts may be added together, separately, and/or co-fed to the wastewater.

In some embodiments, the treatment polymer is added to the wastewater treatment process before, after, and/or concurrently with the inorganic salt. The treatment polymer and inorganic salt may be added at the same location and/or at different locations.

In some embodiments, a composition comprising any one or more of aluminum salt, ferric salt, treatment polymer, and particle is added during a wastewater treatment process. In some embodiments, one or more of the aluminum salt, ferric salt, treatment polymer, and particle may be added separately into the wastewater treatment process, such as by co-feeding. In certain embodiments, the aluminum and/or ferric salt and the treatment polymer are premixed prior to addition to the wastewater.

The amount of treatment polymer and inorganic salt added to the wastewater is not particularly limited. In some embodiments, from 1 ppm to about 10,000 ppm of the inorganic salt is added to the wastewater. For example, from about 1 ppm to about 8,000 ppm, from about 1 ppm to about 6,000 ppm, from about 1 ppm to about 4,000 ppm, from about 1 ppm to about 2,000 ppm, from about 1 ppm to about 1,000 ppm, from about 1 ppm to about 750 ppm, from about 1 ppm to about 500 ppm, from about 1 ppm to about 250 ppm, from about 10 ppm to about 250 ppm, from about 10 ppm to about 500 ppm, from about 10 ppm to about 750 ppm, from about 10 ppm to about 1,000 ppm, from about 10 ppm to about 2,000 ppm, or from about 10 ppm to about 4,000 ppm of the inorganic salt is added to the wastewater.

In some embodiments, from about 1 ppm to about 10,000 ppm of the treatment polymer is added to the wastewater. For example, from about 1 ppm to about 8,000 ppm, from about 1 ppm to about 6,000 ppm, from about 1 ppm to about 4,000 ppm, from about 1 ppm to about 2,000 ppm, from about 1 ppm to about 1,000 ppm, from about 1 ppm to about 750 ppm, from about 1 ppm to about 500 ppm, from about 1 ppm to about 250 ppm, from about 10 ppm to about 250 ppm, from about 10 ppm to about 500 ppm, from about 10 ppm to about 750 ppm, from about 10 ppm to about 1,000 ppm, from about 10 ppm to about 2,000 ppm, or from about 10 ppm to about 4,000 ppm of the treatment polymer is added to the wastewater.

The treatment compositions are suitably applied to a water source in any form. In certain embodiments, the treatment composition is applied as a solution, emulsion, or dispersion. As such, in certain embodiments, the treatment composition includes additional solvents or other additives to achieve a fluid composition, as described above. Nonetheless, in some embodiments, the treatment compositions may be 100% active ingredients, wherein the active ingredients include an inorganic salt, a treatment polymer, and/or a particle as described herein.

In some embodiments, the treatment compounds or the treatment compositions are concentrates (“treatment concentrate”), wherein the total concentration of treatment compounds in the treatment concentrate is about 0.1 wt % to 98 wt % of the total composition; such as about 1 wt % to 75 wt % of the total composition; about 10 wt % to 75 wt % of the total composition; or about 10 wt % to 50 wt % of the total composition.

In some embodiments, the treatment concentrate includes, for example, a treatment polymer, an inorganic salt, and/or a particle as defined herein. In some embodiments, one or more additive or adjuvants, such as solvents, polymers, surfactants, oils, stabilizers, or other components suitable for combining with industrial water sources are included in the treatment concentrate. Where the one or more components of the treatment concentrate include solvent, the solvent is present generally at about 10% to 99.9% by weight of the treatment concentrate.

Described herein are methods of treating a water source with the described treatment composition to eliminate or reduce the targeted material, such as contaminants in the water source.

In an illustrative, non-limiting embodiment, the described composition may be first pre-mixed, thereby resulting in a solution/composition comprising the inorganic salt, such as PAC, and the treatment polymer, such as a CAP; the resulting product has pH at or below pH 4 and is in a non-crosslinked form. The resulting mixture can be added to the water source. The concentrated non-crosslinked or dormant product is fed through a process where diluting water pH causes instantly crosslinking at not too low concentration and at same time the product is dilute enough to avoid gelation. For product containing both PAC and treatment polymer, the pH must remain low typically <4, because the product concentration is typically high (>10 wt %), and high pH can trigger crosslinking within the product and form gel, which renders product unusable.

In an additional illustrative, non-limiting embodiment, the inorganic salt and the treatment polymer may be added directly to a stream where crosslinking occurs at optimal pH and concentration, which is then discharged into the water source. For this dual feed program, due to very low product concentration (typically less than few hundred ppm) the crosslinking becomes less efficient.

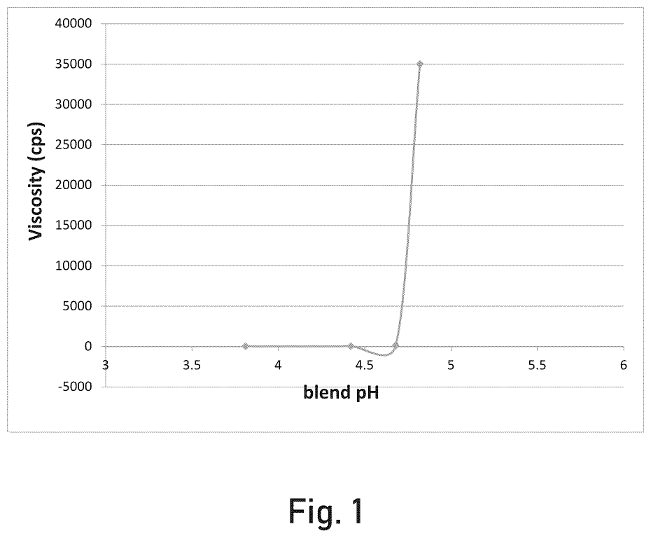

Certain embodiments relate to an onsite or in situ method of treating a water source. The method includes dosing the water source with a treatment comprising a treatment composition comprising an inorganic salt, such as PAC, or a derivative thereof, and a treatment polymer, such as a CAP, wherein the pH of the composition is at or below a pH of about 4. In certain embodiments, the pH of the treated water source can be measured or re-measured to determine whether a follow up treatment with the composition is required. The methods of measuring the pH of the treated water are known to those skilled in the art. If the pH measures at or about pH 6, the dosing of the water source may be adjusted and/or repeated as many times as needed to purify the water source. The PAC and CAP (or whichever inorganic salt and treatment polymer is selected) in the composition interact to form a new structured CAP coagulant, (i.e., CAP crosslinked PAC, treatment polymer crosslinked PAC, colloidal particle) (see Examples and, e.g., the undiluted pH study in FIG. 1 to demonstrate the effect and the Examples). This interaction between PAC and CAP is pH dependent. The new structured CAP coagulant improves performance of the treatment as compared to a conventional wastewater treatment, where, typically, PAC or its derivatives, polyDADMAC are used alone. In some cases, a mixture of PAC with homo polyDADMAC may be used as a standard or conventional treatment, but the polyDADMAC has no reacting carboxylic acid group. This type of mixture is not pH dependent.

In certain embodiments, the inorganic salt and treatment polymer may be premixed prior to the dosing step.

In certain embodiments, the inorganic salt and treatment polymer may be treated with a diluting water of pH of about pH 6 or higher to pre-trigger the crosslinking before the composition is discharged to the water source. The crosslinking is concentration dependent, e.g., if the inorganic salt and treatment polymer interaction is pre-triggered at higher concentration(s), the crosslinking will be more efficient.

In an alternative illustrative embodiment, a method of the present disclosure includes the steps of dosing the water source by co-feeding PAC or a derivative thereof, and a CAP. The pH of the treated water source can be measured following the dosing step or throughout the method to determine whether a follow up treatment/dosing with the composition is required. If the pH measures at below pH 6, the dosing of the water source may be adjusted.

In certain embodiments, the co-feeding of PAC and CAP may be simultaneous. In certain other embodiments, the co-feeding may be sequential. For example, PAC may be added to the water source first, following by the addition of the CAP into the water source. In an alternative example, CAP may be fed into the water source before the PAC is added.

Once the described compositions and methods induce an advanced coagulation process, any contaminants, such as a large amount of bacteria and viruses from the water are precipitated together with the suspended solids.

In certain embodiments, the treatment compositions disclosed herein are effective for treating a water source, such as wastewater, a raw water treatment, an oil sand wastewater, etc. The wastewater may be obtained from, for example, the agricultural industry, food industry, energy industry, iron and steel industries, mining industry, and pulp and paper manufacturing.

In certain alternative embodiments, the described compositions may be for use in retention drainage and flocculation (RDF). In certain further embodiments, the described composition may be for use in mining. The described compositions and methods can be used to improve effluent quality for regulatory compliance and system stability. The compositions and methods of the disclosure can also allow for more accurate chemical dosing for performance optimization and alarms on system issues, such as pump failures and empty chemical tanks, thereby reducing system upsets. The technology disclosed herein can be used in various wastewater automation processes, such as dissolved air flotation (“DAF”) automation and clarification dosage optimization.

The foregoing may be better understood by reference to the following examples, which are intended for illustrative purposes and are not intended to limit the scope of the disclosure or its application in any way.

### EXAMPLES

### Materials

CAS #12042-91-0; Aluminum chloride hydroxide (24% as Al₂O₃).
CAS #14215-15-7; Polyaluminum chloride (27% AlCl₃).
CAS #1327-41-9; Aluminum hydroxychloride.
CAS #26100-47-0; Acrylamide/acrylic acid copolymer.
CAS #53694-17-0; DADMAC/acrylic acid copolymer.
CAS #69418-26-4; Cationic acrylamide copolymer.
CAS #79-06-1; Acrylamide (Am)
CAS #79-10-7; Acrylic acid (AA).
CAS #15214-89-8; ATBS (2-Acrylamido-2-methylpropane sulfonic acid).
CAS #44992-01-0; N,N,N-Trimethyl-2-[(1-oxo-2-propenyl)oxy]-ethanaminium chloride (DMAEA.MCQ).
CAS #48042-45-1. DADMAC, N,N-dimethyl-N-propenyl-2-propen-1-aminium chloride.

### Example 1: PAC Blend Study

To determine an optimal polymer(s) for use in the described compositions, the following polymers (CAP) were evaluated.

TABLE 1

| | | | Molecular |
|---|---|---|---|
| | | Polymer | Weight |
| | | active | (Mw), or |
| Polymer | Polymer Composition | (%) | RSV |
| PMA | polymaleic acid (PMA) | 50.0 | 200 |
| HPMA | hydrolyzed polymaleic | 50.0 | <500 |
| | anhydride (HPMA) | | |
| PMA-AA | poly(maleic acid-co-acrylic acid) | 50.0 | 3000 |
| | (PMA-AA) | | |
| Polymer 1 | 50/50 mol % AA/ATBS | 45.0 | 6000 |
| | copolymer | | |
| Polymer 2 | 90/10 mol % DADMAC/AA | 20.0 | 500K-1000K |
| | copolymer | | |
| Polymer 3 | 95/5 mol % DADMAC/AA | 20.0 | 500K-1000K |
| | copolymer | | |
| Polymer 4 | 40/30/30 mol % | 15.0 | 500K |
| | Am/AA/DMAEA.MCQ | | |
| | copolymer | | |
| Polymer 5 | 50/50 mol % AA/Am solution | 10.0 | 1 mil |
| | polymer | | |
| Polymer 6 | 90/10 mol % Am/AA solution | 20.0 | 100K |
| | polymer | | |
| Polymer 7 | 80/20 mol % Am/AA solution | 20.0 | 100K |
| | polymer | | |
| Polymer 8 | 95/5 mol % Am/AA solution | 20.0 | 100K |
| | polymer | | |
| Polymer 9 | 99/1 mol % Am/AA solution | 20.0 | 100K |
| | polymer | | |
| Polymer 10 | Homo polyDADMAC | 20.0 | 500K |
| Polymer 11 | 48/2/50 mol % | 42.0 | RSV = 19.8 |
| | Am/AA/DMAEA.MCQ | | |
| | copolymer, latex | | |
| Polymer 12 | 45/5/50 mol % | 42.0 | RSV = 19.4 |
| | Am/AA/DMAEA.MCQ | | |
| | copolymer, latex | | |

### Example 2: pH Effect on Viscosity

47.5 g CAS #12042-91-0 (24% active), 2.5 g polymer 2 (20% active) and 10 g deionized water were blended with stirring to give clear solution, and the viscosity and solution pH were recorded (BV=19 cps, pH=3.8). 0.5 g to 1.0 g of 50% sodium hydroxide was added incrementally into the mixture with mixing, the pH of the mixture increased while the solution viscosity also increased.

The pH effect on solution viscosity is shown in FIG. 1. The result demonstrated that the PAC/CAP blend is stable at pH around 4 or below, the PAC/CAP crosslinking reaction is minimized, but when the pH is near 5 or higher the solution viscosity increased significantly, which suggests significant PAC/CAP crosslinking reaction.

### Example 3: Exemplary Blends

Exemplary blends of PAC (CAS #12042-91-0) with PAC are provided in Table 2 below.

TABLE 2
PAC/CAP Blends

| PAC/CAP Blend | active | pH | chemistry (based on active) |
|---|---|---|---|
| PAC blend A | 24.0% | 3.0 | 99/1 of CAS# 12042-91-0/Polymer 2 |
| PAC blend B | 24.0% | 3.0 | 95/5 of CAS# 12042-91-0/Polymer 2 |
| PAC blend C | 24.0% | 3.0 | 95/5 of CAS# 12042-91-0/Polymer 10 |
| PAC blend D | 24.0% | 3.0 | 90/10 of CAS# 12042-91-0/Polymer 2 |
| PAC blend E | 23.0% | 3.0 | 75/25 of CAS# 12042-91-0/Polymer 2 |
| PAC blend F | 20.0% | 3.0 | 98/2 of CAS# 12042-91-0/Polymer 8 |
| PAC blend G | 20.0% | 3.0 | 95/5 of CAS# 12042-91-0/Polymer 8 |

Exemplary blends of carboxylic acid functionalized cationic flocculants blended with aluminum or zirconium compounds are provided in Table 3 below.

TABLE 3
Latex blend of 50 mol % cactionic CAP with PAC or ZrCl₄

| Sample | Base latex polymer | PAC in latex blend |
|---|---|---|
| Latex blend 1 | Polymer 11 | 92.5 ppm CAS# 14215-15-7 |
| Latex blend 2 | Polymer 11 | 370 ppm CAS# 14215-15-7 |
| Latex blend 3 | Polymer 11 | 1850 ppm CAS# 14215-15-7 |
| Latex blend 4 | Polymer 11 | 9250 ppm CAS# 14215-15-7 |
| Latex blend 5 | Polymer 11 | 92500 ppm CAS# 14215-15-7 |
| Latex blend 6 | Polymer 11 | 256 ppm ZrCl₄ |
| Latex blend 7 | Polymer 11 | 512 ppm ZrCl₄ |
| Latex blend 8 | Polymer 12 | 20% CAS# 14215-15-7 |
| Latex blend 9 | Polymer 12 | 10% CAS# 12042-91-0 |

### Example 4: Ultra Dairy

### Materials and Methods

Ultra diary sample was treated with 100, 200, 300, 400, 500 and 600 ppm of PAC (CAS #12042-91-0); 95/5 PAC/CAP (“PAC blend B” CAP is polyDADMAC containing 10% acrylic acid, Polymer 2); 99/1 CAS #12042-91-0/Polymer 2(“PAC blend A”); and 95/5 of CAS #12042-91-0/Polymer 8 (“PAC blend G”). A 40-50% dosage reduction was observed with PAC blend B and PAC blend G compared to CAS #12042-91-0 to achieve similar water clarity.

### Results

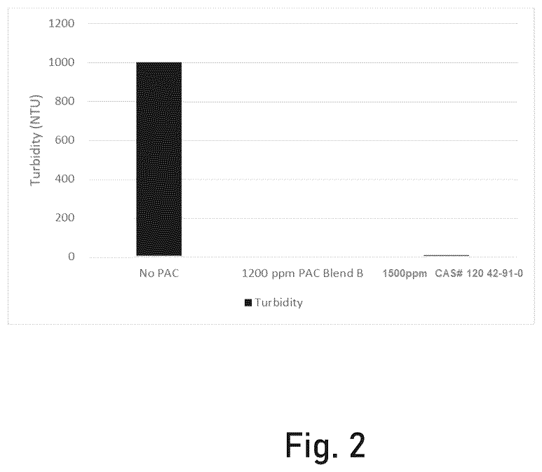

FIG. 2 depicts a graph of the effect of PAC and CAP blended samples at various concentrations on the turbidity of the dairy sample.

### Example 5: Protein Sample

### Materials and Methods

As-received wastewater sample was homogenized and transferred to two 2 L beakers. Beakers were spiked with optimum dosage of CAS #12042-91-0 and PAC blend B. Samples were fast mixed at 250 rpm for 1 min, slow mixed at 50 rpm for 2 mins and settled for 20 min, before taking aliquots for measuring turbidity and oil and grease.

### Results

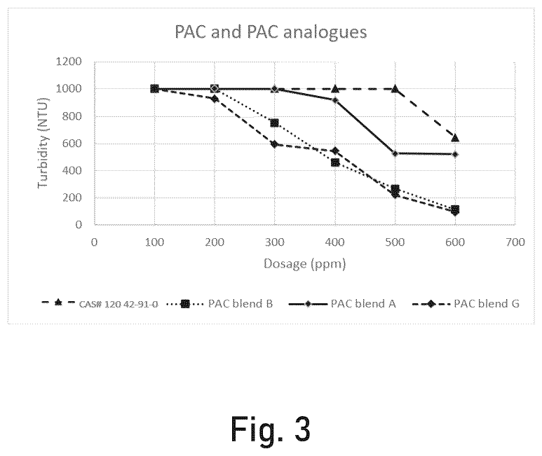

FIG. 3 shows a 5% decrease in oil and grease for 1200 ppm treatment composition of 95/5 PAC/CAP (PAC blend B in the graph; CAP is polyDADMAC containing 10% acrylic acid) as compared to 1500 ppm treatment with PAC alone (CAS #12042-91-0 in the figure). There was no reduction in oil and grease amount with treatment with a control (“blank”).

Conclusions: PAC blend B resulted in similar performance as CAS #12042-91-0 at a significantly lower dosage (20% dosage reduction)

### Example 6: Treatment of Synthetic Oily Water

### Materials and Methods

Synthetic oily water was prepared by emulsifying 300 ppm oleic acid and 300 ppm triolein in tap water to mimic real dairy wastewater. The water was treated with PAC blend B and compared with CAS #12042-91-0 on actives basis. Water samples spiked with said dosage of chemistries were fast mixed at 250 rpm for 1 min, slow mixed at 50 rpm for 2 mins and settled for 20 min before taking aliquots for turbidity measurement.

### Results

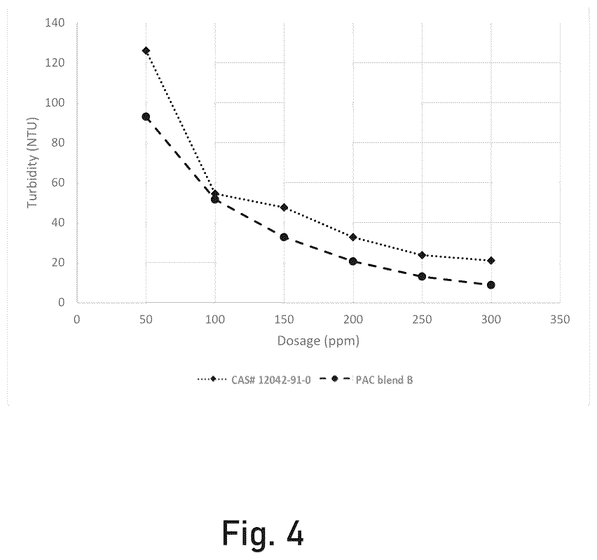

FIG. 4 shows a graph of turbidity vs dosage.

### CONCLUSIONS

Similar performance was achieved with PAC blend B with a 33% dosage reduction compared to CAS #12042-91-0.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a polymer” is intended to include “at least one polymer” or “one or more polymers.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of removing suspended solids from a water source, comprising:
adding a treatment polymer and an inorganic salt to the water source, wherein a weight ratio of the inorganic salt to the treatment polymer added to the water source is from about 0.05:1 to 100:1.

2. The method of claim 1, wherein the inorganic salt is selected from the group consisting of an aluminum salt, a ferric salt, and any combination thereof.

3. The method of claim 1, wherein the treatment polymer comprises a Huggins constant of about 0.0 to about 1.

4. The method of claim 1, wherein the treatment polymer comprises a conformation plot slope of about 0.05 to about 1.

5. The method of claim 2, wherein the aluminum salt is selected from the group consisting of aluminum chloride, aluminum chloride hydrate, aluminum sulfate, alum, polyaluminum sulfate, PAC, aluminum chlorohydrate, a compound having the formula AlₙCl₍₃ₙ₋ₘ₎(OH)ₘ, wherein m is an integer from 0-100, n is an integer from 1-100, and m is less than 3n, and any combination thereof.

6. The method of claim 2, wherein the ferric salt is selected from the group consisting of ferric chloride, ferric sulfate, a polyferric salt, and any combination thereof.

7. The method of claim 1, wherein a composition comprises the treatment polymer and the inorganic salt, further wherein the composition comprises a pH from about 1.0 to about 8.5.

8. The method of claim 1, wherein the treatment polymer is added to the water source before, after, and/or with the inorganic salt.

9. The method of claim 1, wherein the treatment polymer comprises a monomer selected from the group consisting of an anionic monomer, a cationic monomer, a non-ionic monomer, a zwitterionic monomer, and any combination thereof.

10. The method of claim 1, wherein the treatment polymer comprises a monomer selected from the group consisting of acrylamide, methacrylamide, 2-(dimethylamino)ethyl acrylate (“DMAEA”), 2-(dimethylamino)ethyl methacrylate (“DMAEM”), 3-(dimethylamino) propyl methacrylamide (“DMAPMA”), 3-(dimethylamino) propyl acrylamide (“DMAPA”), 3-methacrylamidopropyl-trimethyl-ammonium chloride (“MAPTAC”), 3-acrylamidopropyl-trimethyl-ammonium chloride (“APTAC”), N-vinyl pyrrolidone (“NVP”), diallyldimethylammonium chloride (“DADMAC”), diallylamine, 2-(acryloyloxy)-N,N,N-trimethylethanaminium chloride (“DMAEA.MCQ”), 2-(methacryloyloxy)-N,N,N-trimethylethanaminium chloride (“DMAEM.MCQ”), N,N-dimethylaminoethyl acrylate benzyl chloride (“DMAEA.BCQ”), N,N-dimethylaminoethyl methacrylate benzyl chloride (“DMAEM.BCQ”), 2-acrylamido-2-methylpropane sulfonic acid (“AMPS”), 2-acrylamido-2-methylbutane sulfonic acid (“AMBS”), acrylamide tertbutylsulfonate (“ATBS”), [2-methyl-2-[(1-oxo-2-propenyl)amino]propyl]-phosphonic acid, acrylic acid, methacrylic acid, maleic acid, itaconic acid, a glyoxalated polyacrylamide (GPAM), a polyvinylamine (PVAM), a polyethylenimine (PEI), a polyamidoamine epichlorohydrin (PAE), a salt of any of the foregoing monomer units, and any combination thereof.

11. The method of claim 1, wherein the polymer is cationic, anionic, zwitterionic, non-ionic, amphoteric with a net positive charge or amphoteric with a net negative charge.

12. The method of claim 1, wherein the polymer comprises less than about 25 mol % of a carboxylic acid.

13. The method of claim 1, further comprising forming a colloidal particle with the treatment polymer and the inorganic salt and adding the colloidal particle to the water source.

14. The method of claim 1, further comprising forming a colloidal particle in the water source with the treatment polymer and the inorganic salt.

15. The method of claim 13, wherein the colloidal particle comprises the treatment polymer embedded within a colloidal aluminum hydroxide complex and/or a colloidal ferric hydroxide complex.

16. The method of claim 1, wherein the water source is a wastewater, a raw water, or a combination thereof.

17. The method of claim 1, wherein a pH of the water source is adjusted to between about 5 and about 14.

18. The method of claim 1, further comprising adding a flocculant to the water source.

19. A method of removing suspended solids from a water source, comprising:
adding a composition to the water source, wherein the composition comprises a colloidal particle, the colloidal particle comprising a polymer embedded within a colloidal aluminum hydroxide complex and/or a colloidal ferric hydroxide complex.

20. A method of reducing turbidity of a water source, comprising:
adding a composition to the water source, wherein the composition comprises a colloidal particle, the colloidal particle comprising a polymer embedded within a colloidal aluminum hydroxide complex and/or a colloidal ferric hydroxide complex.
